(19) United States
(12) Patent Application Publication
(10) Pub. No.: US 2012/0046374 A1
(43) Pub. Date: Feb. 23, 2012

(54) EXTRUDED FOAMS WITH IMPROVED STIFFNESS

(75) Inventors: Dietrich Scherzer, Neustadt (DE); Klaus Hahn, Kirchheim (DE); Maximilian Hofmann, Mannheim (DE); Jan Kurt Walter Sandler, Heidelberg (DE); Holger Ruckdäschel, St. Martin (DE)

(73) Assignee: BASF SE, Ludwigshafen (DE)

(21) Appl. No.: 13/211,599

(22) Filed: Aug. 17, 2011

Related U.S. Application Data
(60) Provisional application No. 61/374,641, filed on Aug. 18, 2010.

(51) Int. Cl. C08L 25/06

(52) U.S. Cl. 521/146

(57) ABSTRACT

The present invention relates to an extruded foam based on at least one polymer selected from polysulfone or polyether sulfone, polystyrene, or a copolymer produced from styrene, where the extruded foam comprises at least one mineral filler with a particle sizes ≦10 μm, and comprises at least one nucleating agent based on a wax or on an oligomer containing epoxy groups.

This patent application claims the benefit of pending U.S. provisional patent application Ser. No. 61/374,641 filed Aug. 18, 2010 incorporated in its entirety herein by reference”

The present invention relates to an extruded foam based on a polymer, such as polystyrene, which comprises at least one mineral filler with a particle size ≦10 μm, and comprises at least one nucleating agent. The present invention further relates to a process for producing this type of extruded foam. The extruded foams of the invention feature improved stiffness.

Extruded foams have been known for a long time. By way of example, extruded polystyrene foams (XPS) can be used for the insulation of buildings or of parts of buildings. For said application, the foam sheets have to have minimum thermal conductivity. EP-A 1 661 939 therefore describes extruded foam sheets based on styrene polymers with a density in the range from 20 to 200 kg/m³ and with reduced thermal conductivity. The average cell size of said extruded foam sheets is in the range from 0.08 to 0.25 mm, and their average cell-wall thickness is in the range from 350 to 1500 nm. The extruded foams can also comprise carbon black, graphite, or nucleating agents, such as talc, with an average particle size of 10 μm.

The object of the invention consists in the provision of novel extruded foams, The novel extruded foams are preferably intended to have improved stiffness.

The object is achieved via an extruded foam based on at least one polymer selected from polysulfone or polyether sulfone, polystyrene, or a copolymer produced from styrene, where the extruded foam comprises at least one mineral filler with a particle size ≦10 μm, and comprises at least one nucleating agent based on a wax or on an oligomer.

A feature of the extruded foams of the invention is that the cell walls are reinforced by virtue of the simultaneous addition of at least one mineral filler with a particle size ≦10 μm and of at least one nucleating agent based on a wax or on an oligomer, thus permitting production of particularly stiff foams. The addition of the nucleating agent to the mineral filler can reduce the nucleating effect of the nano- or microparticles (mineral filler), thus permitting addition of larger amounts of said particles. The extruded foams of the invention consequently have improved stiffness and, respectively, compressive strength.

Another advantage of the present invention is that in particular it is possible to increase the strength of the extruded foams in the direction of rise (Y direction in the extrusion process). In this way It is also possible to achieve improved values for compressive stress in relation to the density of the extruded foam.

More detailed definitions are provided below of the extruded foam of the invention, and also of the production process of the invention for said extruded foam.

The extruded foam is based on at least one polymer selected from polysulfone or polyether sulfone, polystyrene, or a copolymer produced from styrene. In other words, this means that the extruded foam of the invention is produced from said polymer via an extrusion process described at a later stage below. It is also optionally possible to use two or more of said polymers for the production of the extruded foam of the invention, but it is preferable to use one of said polymers. Processes for the production of the polymers used in the extrusion process are likewise known to the person skilled in the art.

To the extent that the extruded foam of the invention is based on (at least one) copolymer produced from styrene (another term for these being styrene copolymers), this means that the production of said copolymer requires at least one further monomer, alongside the styrene monomer. Said copolymer is preferably produced from styrene and from one further monomer. Suitable comonomers for styrene are in principle any of the monomers polymerizable with styrene. It is preferable that at least 50% by weight of styrene has been copolymerized within said copolymer.

A copolymer produced from styrene preferably comprises, as comonomer for styrene, a monomer selected from α-methylstyrene, ring-halogenated styrenes, ring-alkylated styrenes, acrylonitrile, acrylic ester, methacrylic ester, N-vinyl compounds, maleic anhydride, butadiene, divinylbenzene, and butanediol diacrylate. Acrylic esters, and also methacrylic esters, are preferably obtainable from alcohols having from 1 to 8 carbon atoms. An example of a suitable N-vinyl compound is vinylcarbazole.

It is preferable that the polymer used in the extruded foam of the invention comprises polystyrene or a styrene-acrylonitrile polymer (SAN).

The extruded foams of the invention preferably comprise cells of which at least 90%, in particular from 95 to 100%, are closed cells to DIN 4590.

The extruded foams of the invention are preferably sheets. They can also optionally be foils or have any other geometry known to the person skilled in the art.

The extruded foam of the invention comprises at least one mineral filler with a particle size ≦10 μm. It is possible in principle to use any mineral filler known to the person skilled in the art, as long as it has a particle size ≦10 μm. Examples of suitable mineral fillers are pulverulent inorganic substances. However, said fillers can also optionally be spherical or fibrous. These fillers are also often termed nucleating agents, because they can affect cell numbers and cell-wall thicknesses in the extruded foams.

Suitable mineral fillers are talc, talc powder, chalk, kaolin, metal oxides, metal hydroxides, such as aluminum hydroxide or magnesium hydroxide, aluminum nitride, silicates, aluminosilicates, barium sulfate, calcium carbonate, calcium sulfate, silica, powdered quartz, Aerosil, alumina, or wollastonite. Preferred silicates are phyllosilicates, such as montmorillonites. The mineral fillers can also optionally be present in coated form. One preferred example of a coated filler is natural montmorillonite modified with quaternary ammonium compounds.

Examples of commercially available mineral fillers are montmorillonites such as Cloisite® 30B from Southern Clay Products, or Microtalk IT Extra talc powder from Mondo Minerals (Amsterdam).

Preferred mineral fillers are a talc powder, a metal oxide, or a silicate. The particle size of the mineral filler In the extruded foams of the invention is preferably from 10 nm to 8 μm, in particular from 50 nm to 6 μm. For the purposes of the present invention, the particle sizes are stated in the form of average particle sizes (D₅₀ value).

The extruded foams of the invention moreover comprise at least one nucleating agent based on a wax or on an oligomer. Nucleating agents of this type, which are also termed reactive compatibilizers, are known to the person skilled in the art. Examples of suitable nucleating agents are the commercially available Luwax products (polyethylene waxes) or Joncryl products (oligomers containing epoxy groups) from BASF SE, Ludwigshafen. The waxes can involve pure or modified polyethylene waxes, for example oxidates or copolymers, and also optionally montan waxes and polyether waxes. The polyethylene waxes are generally produced in a high-pressure process. They are obtainable in the form of micronisate, powder, granules, flakes, or pastilles. The oligomers can involve styrene-acrylate resin solutions, styrene-glycidyl acrylates, film-forming RC dispersions, or colloidal acrylates. Preferred nucleating agent is a polyethylene wax or an oligomer containing epoxy groups.

The extruded foams of the invention can moreover comprise further compounds known to the person skilled in the art. Examples of optional components of this type are IR absorbers, such as carbon black, metal powders, e.g. aluminum powders, titanium dioxide, or graphite, flame retardants, such as organic bromine compounds, or other additives and/or auxiliaries in the form of antistatic agents, stabilizers, or dyes. The extruded foams of the invention can also optionally comprise traces of the blowing agent used in the extrusion process.

The amounts of the mineral filler, of the nucleating agent, and also optionally of further substances comprised in the extruded foams of the invention are those known to the person skilled in the art. The extruded foam preferably comprises from 0.5 to 5% by weight, in particular from 0.5 to 1% by weight, of the mineral filler with a particle size ≦10 μm. The extruded foam preferably comprises from 0.2 to 2% by weight, in particular from 0.5 to 1% by weight, of the nucleating agent. The entirety of the other additives that the extruded foam can comprise is at most 10% by weight, if these are present.

The present invention further provides a process for the production of the extruded foam of the invention. Processes of this type are known in principle to the person skilled in the art. The extruded foams of the invention are preferably produced via extrusion of a melt comprising—as defined above—the polymer, and comprising at least one mineral filler with a particle size ≦10 ≦m, and comprising at least one nucleating agent based on a wax or on an oligomer. Further additives can optionally be present. The extrusion process takes place in the presence of a blowing agent. Suitable blowing agents are known to the person skilled in the art, and volatile organic compounds are usually involved, examples being fluorochlorocarbons, fluorocarbons, hydrocarbons, alcohols, ketones, or ethers. However, it is preferable to use halogen-free blowing agents or blowing agent mixtures, examples being inorganic gases, such as carbon dioxide, nitrogen, argon, and ammonia, optionally in mixtures with alcohols, with hydrocarbons, with ketones, or with ethers. The amounts normally used of the blowing agent are from 3 to 15% by weight, preferably from 4 to 12% by weight, based on the polymer of the extruded foam.

Examples are used below to illustrate the invention.

### EXAMPLE 1

PS 158K polystyrene is processed with the masterbatches of the specified additives (mineral filler, and also nucleating agent: concentration respectively 10% by weight in PS 158K) with addition of 3.3% of CO₂ and 2.35% of ethanol as blowing agents, in an experimental system for producing extruded foams. The term masterbatches means that concentrates of the respective additives in polystyrene are first produced in a respective separate extruder. Said concentrates are then added to the process, with the aim of facilitating the mixing process to incorporate the materials.

The polymers used are introduced together with the additives continuously into a compounding extruder. The total throughput of the polymers is 12 kg/h. The blowing agents (CO₂, ethanol) are introduced continuously through an injection aperture introduced within the compounding extruder. The melt containing blowing agent is cooled in a downstream cooling extruder and is extruded through a slot die. The foaming melt is drawn off, without calibration, by way of a roller conveyor. For a typical density of from 45 to 65 g/l, the height of the extruded cross sections is about 10 to 20 mm, with width about 80 mm. The following standards are used to determine the properties of the finished foam sheets: (1) modulus of elasticity in compression: ISO 381, (2) compressive strength for various degrees of compression: DIN 3386-1, (3) closed-cell factor: DIN ISO 4590.

Components Used

158 K polystyrene (PS 158K): standard polystyrene from BASF SE, Ludwigshafen (Germany)

Luwax: Luwax AH3 powder, a polyethylene wax from BASF SE, Ludwigshafen.

Cloisite: Cloisite 30 B, a montmorillonite from Southern Clay Products, Gonzales, USA (d50%=6 μm) modified with quaternary ammonium compounds.

Talc powder: Microtalc IT Extra from Mondo Minerals, Amsterdam (d50%=1.7 μm). Joncryl ADR 4368: a reactive oligomeric additive containing epoxy groups from BASF SE, Ludwigshafen

TABLE 1

| | | | | | Modulus of | | |
|---|---|---|---|---|---|---|---|
| | | | | | elasticity | Modulus of | Foam |
| | | | Nucle- | | perpendicular | elasticity in | structure |
| Experi- | | Mineral | ating | | to take-off | take-off | (visual |
| ment | | filler | agent | Density | direction | direction | assess- |
| No. | Polymer | % by wt. | % by wt. | g/l | N/mm² | N/mm² | ment) |
| 1 (comp) | PS 158K | | | 52.4 | 6.3 | 16.1 | 3 |
| 2 (comp) | PS 158K | 1.0 | | 52.3 | 6.5 | 14.9 | 4 |
| | | Cloisite | | | | | |
| 3 | PS 158K | 1.0 | 0.6 | 52.3 | 9.8 | 19.9 | 2 |
| | | Cloisite | Luwax | | | | |
| 4 | PS 158K | 1.0 | 0.3 | 50.8 | 10.1 | 17.8 | 2 |
| | | Cloisite | Joncryl | | | | |
| 5 (comp) | PS 158K | 2.0 | | 61.4 | 12.1 | 13.5 | 5 |
| | | Cloisite | | | | | |
| 6 (comp) | PS 158K | 4.0 | | 60.2 | 18.8 | 16.9 | 6 |
| | | Cloisite | | | | | |
| 7 (comp) | PS 158K | 1.0 Talc | | 52.2 | 9.4 | 15.8 | 4 |
| | | powder | | | | | |
| 8 | PS 158K | 1.0 Talc | 0.6 | 52.5 | 12.4 | 15.3 | 2 |
| | | powder | Luwax | | | | |

(comp) = comparative example

The above experiments of table 1 show that the extruded foams of the invention have improved properties (for comparable densities). Improved compressive strength (stiffness) perpendicular to the take-off direction (Y direction in the extrusion process; higher values) can be seen. The extruded foams of the invention moreover exhibit an improved foam structure (lower values) and thus low thermal conductivity. The evaluation of foam structure uses the academic grade system: 1 and 2 are good, 3 and 4 are satisfactory, and 5 and 6 are poor.

1-9. (canceled)

10. An extruded foam based on at least one polymer selected from polysulfone or polyether sulfone, polystyrene, or a copolymer produced from styrene, wherein the extruded foam comprises at least one mineral filler with a particle size ≦10 μm, and comprises at least one nucleating agent based on a wax or on an oligomer.

11. The extruded foam according to claim 10, which comprises from 0.5 to 5% by weight of the mineral filler with a particle size ≦10 μm.

12. The extruded foam according to claim 10, which comprises from 0.2 to 2% by weight of the nucleating agent.

13. The extruded foam according to claim 11, which comprises from 0.2 to 2% by weight of the nucleating agent.

14. The extruded foam according to claim 10, wherein a copolymer produced from styrene has, as comonomer for styrene, a monomer selected from the group consisting of α-methylstyrene, ring-halogenated styrene, ring-alkylated styrene, acrylonitrile, acrylic ester, methacrylic ester, N-vinyl compounds, maleic anhydride, butadiene, divinylbenzene, and butanediol diacrylate.

15. The extruded foam according to claim 13, wherein a copolymer produced from styrene has, as comonomer for styrene, a monomer selected from the group consisting of α-methylstyrene, ring-halogenated styrene, ring-alkylated styrene, acrylonitrile, acrylic ester, methacrylic ester, N-vinyl compounds, maleic anhydride, butadiene, divinylbenzene, and butanediol diacrylate.

16. The extruded foam according to claim 10, wherein the polymer is polystyrene or a styrene-acrylonitrile polymer (SAN).

17. The extruded foam according to claim 15, wherein the polymer is polystyrene or a styrene-acrylonitrile polymer (SAN).

18. The extruded foam according to claim 10, wherein the mineral filler with a particle size ≦10 μm is a talc, a metal oxide, or a silicate.

19. The extruded foam according to claim 17, wherein the mineral filler with a particle size ≦10 μm is a talc, a metal oxide, or a silicate.

20. The extruded foam according to claim 10, wherein the nucleating agent is a polyethylene wax or an oligomer containing epoxy groups.

21. The extruded foam according to claim 19, wherein the nucleating agent is a polyethylene wax or an oligomer containing epoxy groups.

22. The extruded foam according to claim 10, wherein the particle size of the mineral filler is from 10 nm to 8 μm.

23. The extruded foam according to claim 21, wherein the particle size of the mineral filler is from 50 nm to 6 μm.

24. A process for producing an extruded foam according to claim 10 which comprises extruding a melt encompassing the polymer and encompassing at least one mineral filler with a particle size ≦10 μm and encompassing at least one nucleating agent based on a wax or on an oligomer, in the presence of blowing agent.
